(19) United States
(12) Patent Application Publication
(10) Pub. No.: US 2026/0095101 A1
(43) Pub. Date: Apr. 2, 2026

(54) BOOST CIRCUIT AND POWER SUPPLY DEVICE

(71) Applicant: ABLIC Inc., Nagano (JP)

(72) Inventor: Minoru SUDO, Nagano (JP)

(73) Assignee: ABLIC Inc., Nagano (JP)

(21) Appl. No.: 19/302,058

(22) Filed: Aug. 17, 2025

(30) Foreign Application Priority Data
Sep. 30, 2024 (JP) 2024-170209
Apr. 15, 2025 (JP) 2025-066633

(51) Int. Cl. H02M 3/158

(52) U.S. Cl. CPC H02M 3/158

(57) ABSTRACT

A boost circuit receives a storage detection signal from a power storage voltage detection circuit in response to a power storage voltage of a power storage element becoming equal to or higher than a predetermined voltage. The boost circuit includes: a first boost part, including a first buffer circuit pair having small leakage current, in which in the case where the storage detection signal is received, a first boost operation is performed by the first buffer circuit pair driven by power stored in the power storage element and a first boost voltage is output; and a second boost part, including a second buffer circuit pair having large leakage current, in which in the case where the first boost voltage is received, by power stored in the power storage element being supplied to the second buffer circuit pair, a second boost operation is performed and a second boost voltage is generated.

### CROSS-REFERENCE TO RELATED APPLICATION

This application claims the priority benefits of Japan application serial no. 2024-170209, filed on Sep. 30, 2024 and Japan application serial no. 2025-066633, filed on Apr. 15, 2025. The entirety of each of the above-mentioned patent applications is hereby incorporated by reference herein and made a part of this specification.

### BACKGROUND

### Technical Field

The present invention relates to a boost circuit and a power supply device.

### Related Art

Energy harvesting technology is known in which minute energy in various forms such as heat or vibration around us is harvested and converted into electric power.

As an example of realizing the energy harvesting technology, a power supply device has been proposed in which a power storage element stores power generated by a power generation element, and in response to a power storage voltage from the stored power reaching or exceeding a minimum operating voltage of a boost circuit, the boost circuit operates and applies a boost voltage to a load.

As the boost circuit, for example, a Dickson type charge pump circuit that can be integrated, is widely known.

### SUMMARY

In one aspect of the present invention, a boost circuit is provided in which power can be efficiently stored in a power storage element at a front stage.

A boost circuit in one embodiment of the present invention is a boost circuit that receives a storage detection signal from a power storage voltage detection circuit in response to a power storage voltage of a power storage element becoming equal to or higher than a predetermined voltage. The boost circuit includes: a first boost part, including a first buffer circuit pair having small leakage current, in which in a case where the storage detection signal is received, a first boost operation is performed by the first buffer circuit pair driven by power stored in the power storage element and a first boost voltage is output, and in a case where the storage detection signal is not received, the first boost operation is not performed; and a second boost part, including a second buffer circuit pair having higher driving capability and larger leakage current than the first buffer circuit pair, in which in a case where the first boost voltage is received from the first boost part, by the power stored in the power storage element being supplied to the second buffer circuit pair, a second boost operation is performed and a second boost voltage is generated, and in a case where the first boost voltage is not received, the power stored in the power storage element stops being supplied to the second buffer circuit pair.

According to one aspect of the present invention, the boost circuit can be provided in which power can be efficiently stored in the power storage element at the front stage.

### BRIEF DESCRIPTION OF THE DRAWINGS

FIG. 1 is a block diagram illustrating a power supply device according to a first embodiment of the present invention.

FIG. 2 is a block diagram illustrating a boost circuit according to the first embodiment of the present invention.

FIG. 3 is a circuit diagram illustrating a first boost part according to the first embodiment of the present invention.

FIG. 4 is a circuit diagram illustrating a second boost part according to the first embodiment of the present invention.

FIG. 5 is a block diagram illustrating a power supply device according to a second embodiment of the present invention.

FIG. 6 is a block diagram illustrating a power supply device using a conventional boost circuit.

FIG. 7 is a circuit diagram illustrating the boost circuit of FIG. 6.

### DESCRIPTION OF THE EMBODIMENTS

In the following, first, a power supply device using a conventional boost circuit will be described.

Next, based on the configuration of this conventional power supply device, a power supply device using a boost circuit of the present invention will be described by giving several embodiments.

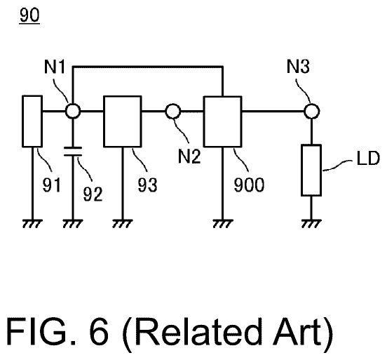

FIG. 6 is a block diagram illustrating a power supply device using a conventional boost circuit.

As illustrated in FIG. 6, a conventional power supply device 90 includes a power generation element 91, a power storage element 92, a power storage voltage detection circuit 93, and a boost circuit 900. In the power supply device 90, the power storage element 92 stores power generated by the power generation element 91, and the power storage voltage detection circuit 93 detects a power storage voltage from the stored power. In response to the power storage voltage becoming equal to or higher than a predetermined voltage, the boost circuit 900 starts a boost operation and applies a boost voltage to a load LD.

The power generation element 91 is a photoelectric conversion element such as a solar cell. The power generation element 91 outputs the generated power from an output terminal to one end of the power storage element 92 via node N1.

Since the power generated by the power generation element 91 like this is generally small, it is difficult to directly drive the load LD. Hence, the power storage element 92 stores the power generated by the power generation element 91 and acts as a power source for the boost circuit 900.

The power storage element 92 is a capacitor that stores the power generated by the power generation element 91. The power storage element 92 has one end connected to node N1 and the other end grounded.

Node N1 is connected to, in addition to the output terminal of the power generation element 91 and one end of the power storage element 92, a detection terminal of the power storage voltage detection circuit 93 and the boost circuit 900. A voltage at node N1 is the power storage voltage of the power storage element 92.

The power storage voltage detection circuit 93 detects whether the power storage voltage of the power storage element 92 has become equal to or higher than the predetermined voltage. Here, the predetermined voltage is a minimum operating voltage of the boost circuit 900, and means a lowest voltage among voltages at which the boost circuit 900 can be normally operated.

In response to detecting that the power storage voltage of the power storage element 92 has become equal to or higher than the minimum operating voltage of the boost circuit 900, the power storage voltage detection circuit 93 outputs a storage detection signal to the boost circuit 900 via node N2. In the case of the power storage voltage of the power storage element 92 being less than the minimum operating voltage of the boost circuit 900, the power storage voltage detection circuit 93 does not output the storage detection signal to the boost circuit 900, and continues the detection operation until the power storage voltage becomes equal to or higher than the minimum operating voltage.

In response to receiving the storage detection signal from the power storage voltage detection circuit 93, the boost circuit 900 starts the boost operation using the power storage element 92 as the power source, and applies the generated boost voltage to the load LD via node N3 to drive the load LD. In the case of receiving no storage detection signal from the power storage voltage detection circuit 93, the boost circuit 900 is on standby until receiving the storage detection signal.

Accordingly, the boost circuit 900 applies the boost voltage to the load LD in an intermittent manner. However, the current consumption in an off state during this standby may hinder efficient power storage operation.

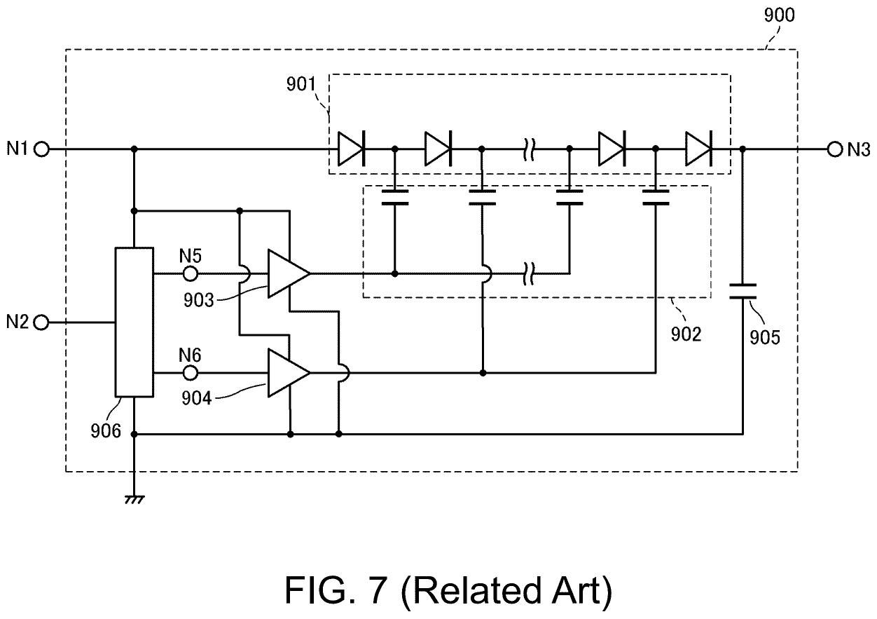

FIG. 7 is a circuit diagram illustrating the boost circuit of FIG. 6.

As illustrated in FIG. 7, the boost circuit 900 is a Dickson type charge pump circuit that can be integrated. The boost circuit 900 includes multiple rectifier elements 901, multiple power storage elements 902, a buffer circuit 903, a buffer circuit 904, a power storage element 905, and an oscillation circuit 906.

In the boost circuit 900, in response to the storage detection signal being received from the power storage voltage detection circuit 93 of FIG. 6, complementary oscillation signals output from the oscillation circuit 906 to two nodes N5 and N6 are output to the multiple power storage elements 902 via the buffer circuits 903 and 904, respectively. Then, by charge and discharge of the multiple power storage elements 902, power is stored in the power storage element 905 while rectification is performed by the multiple rectifier elements 901. Thus, a voltage at node N3 is boosted. The voltage at node N3 becomes a boost voltage of the boost circuit 900.

The buffer circuits 903 and 904 and the oscillation circuit 906 are driven by the power storage voltage at node N1 that has become a voltage equal to or higher than the minimum operating voltage of the boost circuit 900.

Since the buffer circuits 903 and 904 operate as a pair, they may be referred to as a buffer circuit pair 903, 904.

The multiple rectifier elements 901 are formed of multiple diodes connected in series, and are connected between node N1 and node N3.

The multiple power storage elements 902 are formed of multiple capacitors, and one end of each capacitor is connected between each diode of the multiple rectifier elements 901. The other end of each capacitor is alternately connected to output terminals of the buffer circuit pair 903, 904, respectively.

The buffer circuit pair 903, 904 is connected to node N1 and uses the power storage element 92 of FIG. 6 as a power source. The complementary oscillation signals received from the oscillation circuit 906 are output to the multiple power storage elements 902 via the buffer circuit pair 903, 904.

The buffer circuit pair 903, 904 may have high driving capability of internal metal oxide semiconductor (MOS) transistors so that the multiple power storage elements 902 can be charged and discharged at high speed. Since internal MOS transistors having high driving capability have a low on-resistance value, resulting in large leakage current, it is difficult to efficiently store power in the power storage element 92 of FIG. 6.

The power storage element 905 is a capacitor that stores the boosted power of the boost circuit 900. The power storage element 905 has one end connected to node N3 and the other end grounded.

Node N3 is connected to an output terminal of the multiple rectifier elements 901 and one end of the power storage element 905. The voltage at node N3 is a power storage voltage of the power storage element 905 and is also the boost voltage of the boost circuit 900.

The oscillation circuit 906 is connected to the power storage element 92 of FIG. 6 via node N1. In response to the storage detection signal being output from the power storage voltage detection circuit 93 via node N2, the oscillation circuit 906 starts the boost operation and outputs the complementary oscillation signals to the buffer circuit pair 903, 904 via two nodes N5 and N6.

Next, a relationship between an on-resistance value and leakage current in a non-saturation region of a MOS transistor is described.

An on-resistance value Ron in the non-saturation region of the MOS transistor can be represented by the following equation (1).

$$Ron = \frac{1}{μ \cdot Cox \cdot \frac{W}{L} \cdot ( Vgs - Vt )} \qquad ( 1 )$$

Here, W represents gate width of the MOS transistor, and L represent channel length of the MOS transistor. Vgs represent gate-source voltage of the MOS transistor, Vt represent threshold voltage of the MOS transistor, and Cox represent gate oxide capacitance per unit area.

From the above equation (1), by increasing a size ratio (W/L) of the MOS transistor or by increasing Vgs-Vt of the MOS transistor, the on-resistance value Ron can be reduced and the driving capability of the MOS transistor can be improved.

On the other hand, even if the MOS transistor is in an off state, since the leakage current that flows between the drain and source is proportional to the size ratio (W/L) of the MOS transistor, the leakage current increases in response to an increase in the size ratio (W/L) of the MOS transistor. Since this leakage current is proportional to a natural logarithm to the power of (Vgs-Vt), a low threshold voltage Vt is required to reduce the on-resistance value Ron. As a result, it is known that the leakage current increases.

In FIG. 6, assuming that power generation current in the power generated by the power generation element 91 is represented by Ig, the current consumption of the power storage voltage detection circuit 93 is represented by Is, and the current consumption of the boost circuit 900 in the off state during standby is represented by Ib(con), power storage current Ic(con) for the power generation element 91 to cause the power storage element 92 to store power can be represented by the following equation (2).

$$Ic ( con ) = Ig - Is - Ib ( con ) \qquad ( 2 )$$

From the above equation (2), the power storage current Ic (con) becomes a value obtained by subtracting the current consumption Is of the power storage voltage detection circuit 93 and the current consumption Ib(con) in the off state of the boost circuit 900 during standby from the power generation current Ig in the original power generated by the power generation element 91. In other words, in the case of not satisfying the following equation (3), the power storage element 92 is unable to store power with the power generated by the power generation element 91.

$$Ig > Is + Ib ( con ) \qquad ( 3 )$$

In this way, in the conventional boost circuit, in the case of the internal MOS transistor of the buffer circuit pair having high driving capability, the leakage current increases. Thus, efficiently storing power in the power storage element is difficult, and is even more difficult in the case where the power generation element has low power generation capability and small power generation current Ig.

Accordingly, in one embodiment of a boost circuit according to the present invention, a boost part is divided into front stage and rear stage. At the rear stage having high boost capability, a buffer circuit pair having high driving capability is turned off during standby, thereby causing substantially no flow of leakage current and enabling efficient power storage in a power storage element and boosting. The boost part at the front stage only needs to have the capability to boost a voltage sufficient to turn on and off a switching element connected to a power line of the buffer circuit pair at the rear stage, and a buffer circuit pair having low driving capability suffices. Hence, the leakage current can be reduced.

Accordingly, in one embodiment of the boost circuit according to the present invention, leakage current can be reduced compared to the conventional boost circuit. Hence, even in the case of a power generation element having low power generation capability and small power generation current Ig, it is possible to efficiently store power in the power storage element, perform boosting and drive a load.

Hereinafter, embodiments for carrying out the present invention will be described in detail with reference to the drawings.

In the drawings, the same reference numerals are assigned to the same components, and duplicate descriptions may be omitted.

### First Embodiment

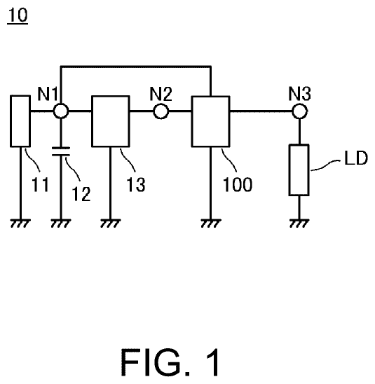

FIG. 1 is a block diagram illustrating a power supply device according to a first embodiment of the present invention.

As illustrated in FIG. 1, a power supply device 10 according to the present embodiment includes a power generation element 11, a power storage element 12, a power storage voltage detection circuit 13, and a boost circuit 100. Comparing the power supply device 10 with the conventional power supply device 90 illustrated in FIG. 6, the boost circuit 100 differs from the boost circuit 900.

The power generation element 11 is the same as the power generation element 91, the power storage element 12 is the same as the power storage element 92, the power storage voltage detection circuit 13 is the same as the power storage voltage detection circuit 93, and descriptions thereof are thus omitted.

The load LD can be appropriately selected without particular limitation, and is preferably, for example, a wireless communication module, in terms of being capable of forming a “self-powered remote sensor device.” In the case where the load LD is a wireless communication module, if the power generation element 11 generates power, communication from the wireless communication module becomes frequent; if no power is generated, communication from the wireless communication module is stopped. Thus, a “self-powered remote sensor device” can be formed in which the frequency of communication becomes sensor sensitivity. The power supply device 10 is provided in a portable device capable of wireless communication, and supplies power generated by the power generation element 11 to the wireless communication module.

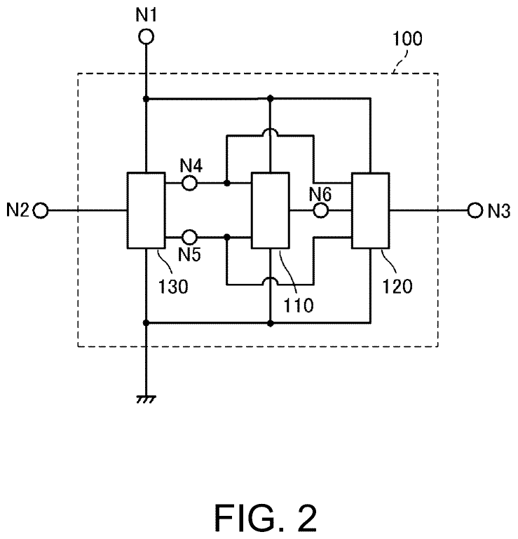

FIG. 2 is a block diagram illustrating a boost circuit according to the first embodiment of the present invention.

As illustrated in FIG. 2, the boost circuit 100 according to the present embodiment includes a first boost part 110 at a front stage having low boost capability, a second boost part 120 at a rear stage having high boost capability, and an oscillation circuit 130. The boost circuit 100 is supplied with power stored in the power storage element 12 from node N1 and is driven.

In the boost circuit 100, in response to a storage detection signal being received from the power storage voltage detection circuit 13 of FIG. 1 via node N2, complementary oscillation signals are output from the oscillation circuit 130 via two nodes N4 and N5, by which the first boost part 110 performs a boost operation and generates a first boost voltage. Next, in the boost circuit 100, in response to the first boost part 110 outputting the first boost voltage from node N6 to the second boost part 120, the second boost part 120 turns on and applies a second boost voltage generated to the load LD illustrated in FIG. 1 from node N3, thus driving the load LD.

The second boost part 120 may be operated according to an oscillation signal from an oscillation circuit different from the oscillation circuit 130. However, by using a common oscillation circuit with the first boost part 110, the number of oscillation circuits can be reduced, and thus the current consumption of the boost circuit 100 can be reduced.

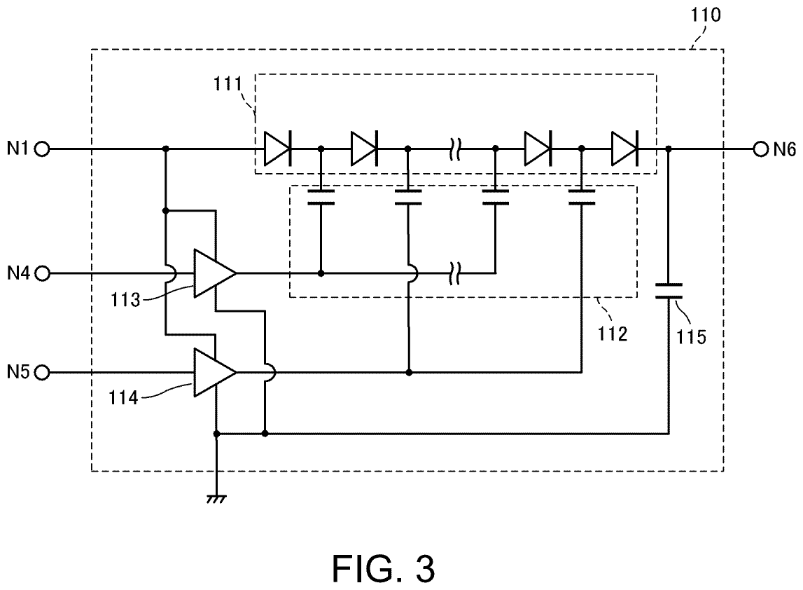

FIG. 3 is a circuit diagram illustrating the first boost part according to the first embodiment of the present invention.

As illustrated in FIG. 3, the first boost part 110 includes multiple rectifier elements 111, multiple power storage elements 112, a buffer circuit 113 and a buffer circuit 114 as a first buffer circuit pair, and a power storage element 115.

The buffer circuits 113 and 114 are supplied with power stored in the power storage element 12 from node N1 and are driven. The buffer circuits 113 and 114, in response to receiving complementary oscillation signals output by the oscillation circuit 130 via nodes N4 and N5, perform a first boost operation, and generate a first boost voltage with the multiple rectifier elements 111, the multiple power storage elements 112, and the power storage element 115. Since the buffer circuits 113 and 114 operate as a pair, they may be referred to as a buffer circuit pair 113, 114.

The rectifier elements 111 and power storage elements 112 are smaller in size than the conventional rectifier elements 901 and power storage elements 902.

The power storage element 115 is also smaller in size than the conventional power storage element 905.

The oscillation circuit 906 illustrated in FIG. 7 corresponds to the oscillation circuit 130 illustrated in FIG. 2, and is thus not described in FIG. 3.

In response to the storage detection signal being output from the power storage voltage detection circuit 13, the first boost part 110 starts a boost operation using the power storage element 12 as a power source, and outputs the generated first boost voltage to the second boost part 120 via node N6. In the case of no storage detection signal being output from the power storage voltage detection circuit 13, the first boost part 110 is on standby until the storage detection signal is output.

Accordingly, the first boost part 110 applies the first boost voltage to the second boost part 120 in an intermittent manner. This first boost voltage becomes a trigger for turning on the second boost part 120 in an intermittent manner.

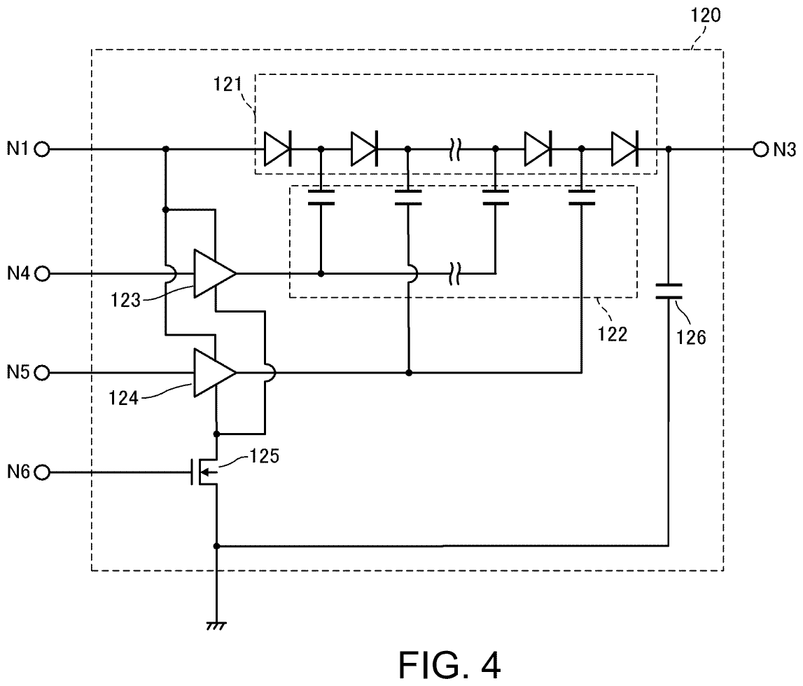

FIG. 4 is a circuit diagram illustrating the second boost part according to the first embodiment of the present invention.

As illustrated in FIG. 4, the second boost part 120 includes multiple rectifier elements 121, multiple power storage elements 122, a buffer circuit 123 and a buffer circuit 124 as a second buffer circuit pair, a switching element 125 as a first switching element, and a power storage element 126.

The buffer circuits 123 and 124 are supplied with the power stored in the power storage element 12 from node N1 and are driven. The buffer circuits 123 and 124, in response to receiving the complementary oscillation signals output by the oscillation circuit 130 via nodes N4 and N5, performs a second boost operation, and generate a second boost voltage with the multiple rectifier elements 121, the multiple power storage elements 122, and the power storage element 126. Since the buffer circuits 123 and 124 operate as a pair, they may be referred to as a buffer circuit pair 123, 124.

Comparing the second boost part 120 with the conventional boost circuit 900 illustrated in FIG. 7, a difference lies in that the switching element 125 is connected between each ground terminal of the buffer circuit pair 123, 124 and GND.

The buffer circuit pair 123, 124 of the second boost part 120 is the same as the conventional buffer circuit pair 903, 904, the rectifier elements 121 and power storage elements 122 are the same as the conventional rectifier elements 901 and power storage elements 902, and descriptions thereof are thus omitted.

The switching element 125 is a MOS transistor, with its drain connected to each ground terminal of the buffer circuit pair 123, 124, its gate connected to an output terminal of the first boost part 110 of FIG. 3 via node N6, and its source grounded. That is, the switching element 125 is provided on a power line of the buffer circuit pair 123, 124, and can be controlled to be on and off with the first boost voltage. Specifically, in response to the switching element 125 being turned on, the power stored in the power storage element 12 is supplied to the buffer circuit pair 123, 124; in response to the switching element 125 being turned off, the power stored in the power storage element 12 stops being supplied to the buffer circuit pair 123, 124.

The MOS transistor as the switching element 125 has a larger potential difference between the source and the gate during turning-on than an internal MOS transistor of the buffer circuit pair 123, 124. Hence, the MOS transistor as the switching element 125 can be reduced in leakage current compared to conventional MOS transistors.

In the second boost part 120, in the case where the switching element 125 receives the first boost voltage from the first boost part 110 of FIG. 3 via node N6, the switching element 125 is turned on. Then, in the second boost part 120, the buffer circuit pair 123, 124 performs the second boost operation to generate the second boost voltage, and applies the second boost voltage to the load LD of FIG. 1 via node N3. In the second boost part 120, in the case where the first boost voltage is not received, the switching element 125 is turned off. Thus, substantially no leakage current flows in the buffer circuit pair 123, 124.

Furthermore, since the first boost voltage received by the switching element 125 only needs to be sufficient to turn the switching element 125 on and off, the boost capability of the first boost part 110 can be made lower than the boost capability of the second boost part 120. The reason is that it is only necessary to apply a voltage to the gate that is sufficient to turn on the switching element 125 of the second boost part 120, and substantially no current is required. That is, the buffer circuit pair 123, 124 may have lower driving capability than the conventional buffer circuit pair 903, 904. Since small driving capability of a buffer circuit means that a size ratio (W/L) of a MOS transistor in the buffer circuit can be reduced, the leakage current in the off state during standby can be significantly reduced compared to the conventional boost circuit 900.

Next, the leakage current of the conventional boost circuit and the leakage current of the present embodiment are described.

Leakage current Il(con) of the conventional boost circuit 900 is the sum of leakage current Ilo of the oscillation circuit 906, leakage current Ilb1 of the buffer circuit 903, and leakage current Ilb2 of the buffer circuit 904, as expressed in the following equation (4).

$$Il ( con ) = Ilo + Ilb 1 + Ilb 2 \qquad ( 4 )$$

On the other hand, leakage current Il of the boost circuit 100 of the present embodiment is the sum of leakage current Ilo of the oscillation circuit 130, leakage current Il1 of the buffer circuit pair 113, 114, and leakage current Il2 of the buffer circuit pair 123, 124, as expressed in the following equation (5).

The leakage current Ilo of the oscillation circuit 130 is the same as the leakage current Ilo (con) of the conventional oscillation circuit 906.

$$Il = Ilo + Il 1 + Il 2 \qquad ( 5 )$$

Here, the leakage current Il2 of the buffer circuit pair 123, 124 of the second boost part 120 is substantially zero. Accordingly, the leakage current Il1 of the buffer circuit pair 113, 114 of the first boost part 110 is much smaller than the sum “Ilb1+Ilb2” of the leakage current of the buffer circuit pair 903, 904 of the conventional boost circuit 900. Thus, Il(con)>>Il is achieved.

Assuming that power generation current of the power generation element 11 is represented by Ig, the current consumption of the power storage voltage detection circuit 13 is represented by Is, and the current consumption of the boost circuit 100 in the off state during standby is represented by Ib, power storage current Ic for the power generation element 11 to cause the power storage element 12 to store power can be represented by the following equation (6).

$$Ic = Ig - Is - Ib \qquad ( 6 )$$

In this way, the boost circuit 100 of the present embodiment includes the first boost part 110 and the second boost part 120, in which the first boost part 110 and the second boost part 120 are obtained by dividing a boost part using the power storage element 12 as a power source into the front stage and rear stage.

The first boost part 110 includes the buffer circuit pair 113, 114 that has lower driving capability and smaller leakage current than the conventional buffer circuit pair 903, 904. In the first boost part 110, in the case where the storage detection signal is received from the power storage voltage detection circuit 13, the first boost operation is performed and the first boost voltage is output to the second boost part 120; in the case where the storage detection signal is not received, the first boost operation is not performed.

The second boost part 120 includes the buffer circuit pair 123, 124 as the second buffer circuit pair that has higher driving capability and larger leakage current than the buffer circuit pair 113, 114. In the second boost part 120, in the case where the first boost voltage is received from the first boost part 110, the buffer circuit pair 123, 124 is turned on and the second boost voltage is generated; in the case where the first boost voltage is not received, the buffer circuit pair 123, 124 is turned off.

Accordingly, in the boost circuit 100, the leakage current of the first boost part 110 can be reduced and the leakage current of the second boost part 120 can be made substantially zero.

Thus, the boost circuit 100 can be reduced in leakage current compared to the conventional boost circuit 900. Thus, even with a power generation element having low power generation capability and small power generation current Ig, in the boost circuit 100, power can be efficiently stored in the power storage element 12, boosting can be efficiently performed, and the load LD can be efficiently driven.

### Second Embodiment

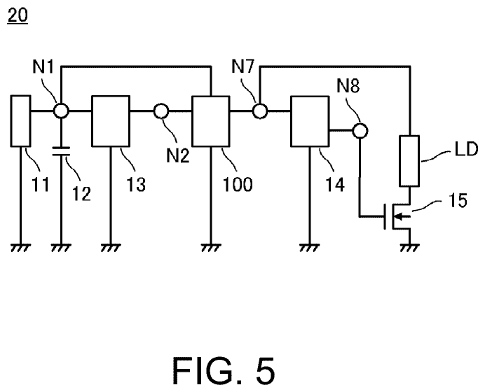

FIG. 5 is a block diagram illustrating a power supply device according to a second embodiment of the present invention.

As illustrated in FIG. 5, a power supply device 20 according to the second embodiment is the same as the first embodiment except that a boost voltage detection circuit 14 and a switching element 15 are further provided in the power supply device 10 according to the first embodiment illustrated in FIG. 1.

A difference between the power supply device 10 and the power supply device 20 lies in that, in response to the boost voltage detection circuit 14 detecting a second boost voltage and the second boost voltage becoming equal to or higher than a voltage at which the load LD can be normally operated, the switching element 15 is turned on to drive the load LD.

Node N7 is connected to, in addition to an output terminal of the boost circuit 100 and one end of the load LD, a detection terminal of the boost voltage detection circuit 14. A voltage at node N7 is the second boost voltage boosted by the second boost part 120, and is monitored by the boost voltage detection circuit 14 until becoming equal to or higher than the voltage at which the load LD can be normally operated.

In response to the voltage at node N7 becoming equal to or higher than the second boost voltage of a predetermined voltage or higher, the boost voltage detection circuit 14 outputs the storage detection signal from an output terminal to the switching element 15 via node N8.

Here, the predetermined voltage means a voltage at which the load LD can be normally operated.

The switching element 15 is a MOS transistor, with its drain connected to a ground side of the load LD, its gate connected to the output terminal of the boost voltage detection circuit 14 via node N8, and its source grounded. Like the switching element 125 of the first embodiment, the switching element 15 has a high threshold voltage.

In this way, in the second embodiment, in response to the boost voltage detection circuit 14 detecting the second boost voltage and the second boost voltage becoming equal to or higher than the voltage at which the load LD can be normally operated, the switching element 15 is turned on to operate the load LD. Then, in the case where the load LD has large leakage current, while it is difficult for the second boost voltage to boost in the first embodiment, in the second embodiment, the leakage current of the load LD is cut off by the switching element 15 until the second boost voltage becomes equal to or higher than the predetermined voltage. Accordingly, in the power supply device 20, even in the case where the load LD has large leakage current, the load can be efficiently operated.

As described above, the boost circuit according to one embodiment of the present invention receives the storage detection signal from the power storage voltage detection circuit in response to the power storage voltage of the power storage element becoming equal to or higher than a predetermined voltage. The boost circuit includes the first boost part and the second boost part. The first boost part includes the first buffer circuit pair having low driving capability and small leakage current. In the case where the first buffer circuit pair receives the storage detection signal, the first boost operation is performed by the first buffer circuit pair driven by the power stored in the power storage element and the first boost voltage is output; in the case where the first buffer circuit pair does not receive the storage detection signal, the first boost operation is not performed. The second boost part includes the second buffer circuit pair having higher driving capability and larger leakage current than the first buffer circuit pair. In the second boost part, in the case where the first boost voltage is received from the first boost part, by the power stored in the power storage element being supplied to the second buffer circuit pair, the second boost operation is performed and the second boost voltage is generated. In the case where the first boost voltage is not received, the power stored in the power storage element stops being supplied to the second buffer circuit pair.

Accordingly, in the boost circuit, since the leakage current of the first boost part can be reduced and the leakage current of the second boost part as the main part can be made substantially zero, power can be efficiently stored in the power storage element at the front stage even in the case of the power generation element having low power generation capability.

Although each embodiment of the present invention has been described above, the present invention is not limited to these embodiments, and various modifications are possible within a scope that does not depart from the spirit of the present invention.

For example, in each embodiment, the power storage voltage detection circuit and the boost circuit can all be integrated. By the integration, the boost circuit can be reduced in size and weight and can be easily applied to an Internet of Things (IoT) device or the like.

Furthermore, while the power generation element is a photoelectric conversion element in each embodiment, the power generation element is not limited thereto as long as it is an element capable of converting some energy into electricity, and may be, for example, a thermoelectric conversion element such as a Peltier element, a magnetoelectric conversion element such as a Hall element, or the like.

Furthermore, while the load is a wireless communication module in each embodiment, the load is not limited thereto.

In FIG. 3, an element for discharging electric charge, such as a high-resistance resistor element, may be connected between node N6 connected to the output terminal of the first boost part 110 and GND.

The power storage voltage detection circuit and the boost voltage detection circuit may have hysteresis in detection voltage and release voltage.

What is claimed is:

1. A boost circuit, receiving a storage detection signal from a power storage voltage detection circuit in response to a power storage voltage of a power storage element becoming equal to or higher than a predetermined voltage, the boost circuit comprising:
a first boost part, comprising a first buffer circuit pair having small leakage current, in which in a case where the storage detection signal is received, a first boost operation is performed by the first buffer circuit pair driven by power stored in the power storage element and a first boost voltage is output, and in a case where the storage detection signal is not received, the first boost operation is not performed; and
a second boost part, comprising a second buffer circuit pair having higher driving capability and larger leakage current than the first buffer circuit pair, in which in a case where the first boost voltage is received from the first boost part, by the power stored in the power storage element being supplied to the second buffer circuit pair, a second boost operation is performed and a second boost voltage is generated, and in a case where the first boost voltage is not received, the power stored in the power storage element stops being supplied to the second buffer circuit pair.

2. The boost circuit according to claim 1, further comprising:
a first switching element, provided on a power line of the second buffer circuit pair, and supplying the power stored in the power storage element by turning on with the first boost voltage.

3. The boost circuit according to claim 2, wherein
the first switching element is a MOS transistor; and
the MOS transistor has a larger potential difference between a source and a gate during turning-on than an internal MOS transistor of the first buffer circuit pair and the second buffer circuit pair.

4. The boost circuit according to claim 3, wherein
the first boost voltage is applied to the gate of the MOS transistor as the first switching element.

5. The boost circuit according to claim 1, wherein
the first boost operation and the second boost operation are performed according to an oscillation signal from a common oscillation circuit.

6. A power supply device, comprising:
a power generation element, outputting generated power;
a power storage element, storing the power generated by the power generation element;
a power storage voltage detection circuit, outputting a storage detection signal in a case where a power storage voltage of the power storage element is equal to or higher than a predetermined voltage, and not outputting the storage detection signal in a case where the power storage voltage is lower than the predetermined voltage;
the boost circuit according to claim 1, in which in a case where the storage detection signal is received from the power storage voltage detection circuit, by the second boost operation triggered by the first boost voltage generated by the first boost operation using the power storage element as a power source, the second boost voltage is generated, and in a case where the storage detection signal is not received, the first boost operation is not performed; and
a load, to which the second boost voltage is applied.

7. The power supply device according to claim 6, further comprising:
a boost voltage detection circuit, outputting a boost detection signal in a case where the second boost voltage is equal to or higher than a predetermined voltage, and not outputting the boost detection signal in a case where the second boost voltage is lower than the predetermined voltage; and
a second switching element, connected in series with the load and able to be controlled to be on and off with the boost detection signal.

8. The power supply device according to claim 6, wherein
the load is a wireless communication module.
